(19) United States
(12) Patent Application Publication
(10) Pub. No.: US 2022/0250408 A1
(43) Pub. Date: Aug. 11, 2022

(54) DIAGENETIC CEMENTATION SOLUTION AND METHOD FOR MANUFACTURING SAND SCULPTURE WITH SAME

(71) Applicant: HOHAI UNIVERSITY, Jiangsu (CN)

(72) Inventors: Yufeng GAO, Jiangsu (CN); Hao MENG, Jiangsu (CN); Shuang SHU, Jiangsu (CN); Yi ZHANG, Jiangsu (CN); Boyang YAN, Jiangsu (CN); Yongshuai QI, Jiangsu (CN)

(73) Assignee: HOHAI UNIVERSITY, Jiangsu (CN)

(21) Appl. No.: 17/608,164

(22) PCT Filed: Nov. 19, 2020
(86) PCT No.: PCT/CN2020/130030

§ 371 Date: Nov. 2, 2021

(30) Foreign Application Priority Data
Feb. 25, 2020 (CN) 202010115687.9

(51) Int. Cl. B44C 1/22; B44C 3/06

(52) U.S. Cl. CPC B44C 1/225; B44C 3/06

(57) ABSTRACT

Provided in the present invention is a diagenetic cementation solution and a method for manufacturing a sand sculpture with the same. The diagenetic cementation solution includes a urease-containing plant powder, urea, calcium salt and a cementation solution, wherein the urease-containing plant powder is dissolved in the cementation solution in a mass ratio of 10:50 to 1:50, a resulting mixture is stirred and left to stand for a period of time, and a supernate is reserved; a mixture of the urea and the calcium salt is dissolved in the supernate in a mass ratio of 1:5 to 1:20. The method for manufacturing a sand sculpture includes: ramming a foundation by means of the diagenetic cementation solution, mounting a form and piling sand, pouring and ramming, and removing the form and carrying out sculpturing.

### BACKGROUND

### Technical Field

The present invention belongs to the technical field of sand sculpture manufacturing, and particularly relates to a diagenetic cementation solution and a method for manufacturing a sand sculpture with the same.

### Description of Related Art

Sand sculptures are made of sand, and feature diversity, fast decay and environmental friendliness. In deserts, beaches, etc., sand sculptures are usually used as exhibitions or features to attract tourists, and have been closely combined with tourism, thereby increasing local tourism income and economic benefits.

Sand is a typical dispersive material, and accordingly some technologies are required to make up for the disadvantage that sand is non-adhesive and non-bondable. Traditionally, excess water is poured into sand to compact sand particles under their self-weight pressure and seepage pressure of water, so as to make the sand sculpture. However, with the evaporation and loss of water, sand sculptures treated only with water quickly return to a loose state, which is particularly serious in dry deserts and windy coasts.

Another method for manufacturing a sand sculpture is to spray glue on the surface of the sand sculpture after the sand sculpture is formed, to inhibit water loss in the sand sculpture and make grit particles adsorb together under the action of pore water. In this way, the sand sculpture is not resistant to rain and low temperature, and can only exist for several months. After the rainy season or winter, the surface layer will fall off, and sequentially, the sand sculpture will be destroyed quickly. In addition, this way of spraying glue on the surface of the sand sculpture is too single, and the phenomenon of “sand collapse” will appear under any carelessness, which is a great challenge for the skills of sand sculptors. The white latex commonly used will cause pollution in the process of manufacturing large-area sand sculpture groups.

Moreover, the method for manufacturing the sand sculpture with cement is also available. The method requires a large amount of cement to be added, which will seriously pollute the environment and emit greenhouse gases. The excess cement will flow into the nearby water body with water flow, resulting in groundwater pollution.

### SUMMARY

In order to solve the above problem, the present invention provides a diagenetic cementation solution and a method for manufacturing a sand sculpture with the same, which may improve density and strength of a sand sculpture, thereby achieving effects of strengthening a surface of the sand sculpture and prolonging life of the sand sculpture without pollution to an environment.

The technical solutions are as follows. The present invention provides the diagenetic cementation solution. The diagenetic cementation solution includes a urease-containing plant powder, urea, calcium salt and a cementation solution, wherein the urease-containing plant powder is dissolved in the cementation solution in a mass ratio of 10:50 to 1:50, a resulting mixture is stirred and left to stand for a period of time, and a supernate is reserved, and a mixture of the urea and the calcium salt is dissolved in the supernate in a mass ratio of 1:5 to 1:20.

Further, the calcium salt is one or more from the group consisting of calcium chloride, calcium formate and calcium nitrate, and a mass ratio of the urea to the calcium salt in the mixture of the urea and the calcium salt is 1:1 to 1:2.

Further, the calcium salt is calcium acetate, and a mass ratio of the urea to the calcium salt in the mixture of the urea and the calcium salt is 3:8 to 6:8.

Further, the urease-containing plant powder is ground from one or more from the group consisting of sword beans, soybeans, pine leaves and watermelon seeds.

Further, the cementation solution is prepared by dissolving one of gelatin, xanthan gum or carrageenan in water in a mass ratio of 0.5%.

The present invention further provides a method for manufacturing a sand sculpture. The method includes the following steps:

S1, ramming a foundation: pouring water or a diagenetic cementation solution into the foundation, simultaneously adding sand, and ramming or rolling the foundation at the same time;

S2, mounting a form and piling sand: mounting a vertical form above the foundation and filling the form with the sand;

S3, pouring and ramming: pouring the diagenetic cementation solution into an outer surface layer of the sand 10-20 cm away from the form, and pouring water into the sand at an inner side after the sand is piled each time; and ramming each layer of sand after pouring;

S4, repeating the step S2 and the step S3 until a sand pile reaches a designed height and size, finally pouring the diagenetic cementation solution into a top layer of the sand pile and ramming same; and

S5, removing the form and carrying out sculpturing: carrying out form removing and sculpturing in about three days after sand piling and pouring.

Further, a thickness of the sand for filling each time in the step S2 is 10-30 cm.

Further, a pouring volume of the diagenetic cementation solution in the step S3 is 1.5-3 times a natural pore volume of the sand.

Further, a pouring volume of the water in the step S3 is 1.5-3 times the natural pore volume of the sand.

Beneficial effects: 1. The diagenetic cementation solution is poured on the surface of the sand sculpture in a layered manner, and reacts on the surface of the sand sculpture to generate calcite. In this way, the present invention may remarkably improve surface strength of the sand sculpture to make the sand sculpture resistant to rainwater and a low temperature and prolong life of the sand sculpture.

2. Use of a method of regional pouring of pouring the water at an inner side of the sand sculpture and pouring the diagenetic cementation solution at an outer side of the sand sculpture may not only ensure strength of an outer surface of the sand sculpture and reduce evaporation of the water, but also greatly reduce cost.

3. Use of the cementation solution with high viscosity in the diagenetic cementation solution may slow down infiltration of a liquid, thereby increasing reaction time of the diagenetic cementation solution and formation of the calcite between grit particles.

4. The urease-containing plant powder and the cementation solution in the diagenetic cementation solution may both be degraded under a natural condition, thereby avoiding pollution and an influence on an ambient environment.

### BRIEF DESCRIPTION OF THE DRAWINGS

FIG. 1 is a schematic diagram of ramming a foundation to manufacture a sand sculpture of the present invention.

FIG. 2 is a schematic diagram of mounting a form to manufacture the sand sculpture of the present invention.

FIG. 3 is a schematic diagram of piling and regionally pouring sand to manufacture the sculpture of the present invention.

FIG. 4 is a schematic diagram of completion of sand piling of the sand sculpture of the present invention.

FIG. 5 is a schematic diagram of sand particles before pouring a diagenetic cementation solution of the present invention.

FIG. 6 is a schematic diagram of the sand particles after pouring the diagenetic cementation solution of the present invention.

FIG. 7 is penetration strength of a sample treated with the diagenetic cementation solution.

FIG. 8 is a scanning electron microscope image of an untreated sample.

FIG. 9 is a scanning electron microscope image of the sample treated with the diagenetic cementation solution.

### DESCRIPTION OF THE EMBODIMENTS

The present invention provides a diagenetic cementation solution. The diagenetic cementation solution includes a urease-containing plant powder, urea, calcium salt and a cementation solution, where the urease-containing plant powder is dissolved in water or the cementation solution in a mass ratio of 10:50 to 1:50, stirred and left to stand for about half hour, then a supernate, that is, a plant urease crude extract is reserved, and a mixture of the urea and the calcium salt is dissolved in the plant urease crude extract in a mass ratio of 1:5 to 1:20.

When the calcium salt is one or more from the group consisting of calcium chloride, calcium formate and calcium nitrate, a mass ratio of the urea to the calcium salt in the mixture of the urea and the calcium salt is 1:1 to 1:2.

When the calcium salt is calcium acetate, a mass ratio of the urea to the calcium salt in the mixture of the urea and the calcium salt is 3:8 to 6:8.

The urease-containing plant powder is ground from one or more from the group consisting of sword beans, soybeans, pine leaves and watermelon seeds.

The cementation solution is prepared by dissolving one of gelatin, xanthan gum or carrageenan in water in a mass ratio of 0.5%.

The present invention further provides a method for manufacturing a sand sculpture. The method includes the following steps.

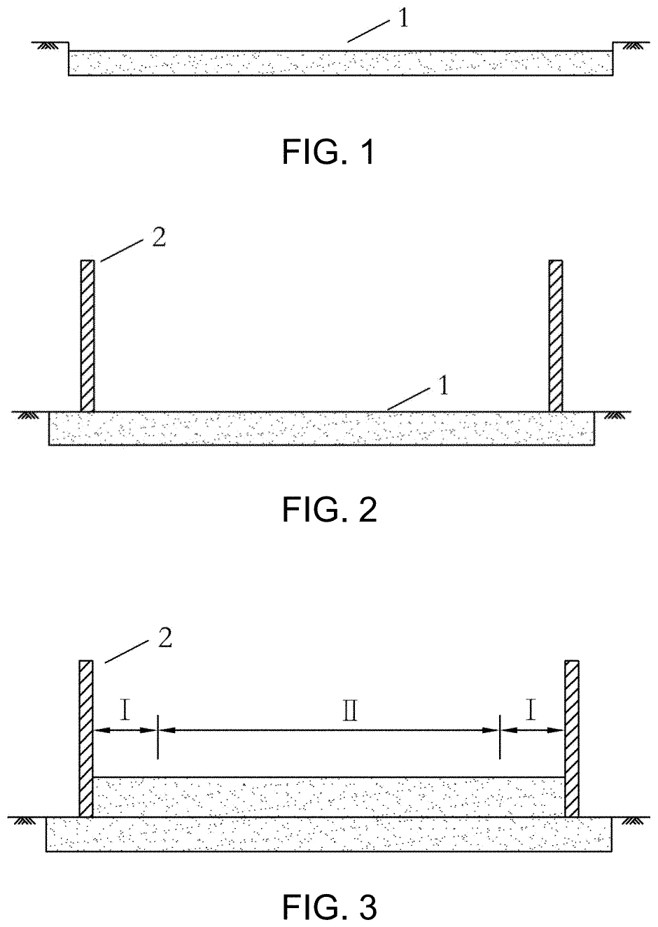

S1: A foundation is rammed: as shown in FIG. 1, a site is divided according to a design solution for ramming the foundation 1, so as to ensure that the foundation 1 may bear weight of an upper sand sculpture without damage of the upper sand sculpture caused by differential settlement. Water or the diagenetic cementation solution is poured into the foundation 1, sand is simultaneously added, uniform pouring is ensured as far as possible in this process, and ramming or rolling is carried out while pouring is carried out. Sand adding amount depends on a subsidence speed of the foundation 1 after pouring, pouring amount is roughly the same as the sand adding amount, and a pouring speed depends on a sand adding speed. Foundation ramming is completed when the foundation 1 is rammed to a designed elevation. The site is placed for about three days after the foundation 1 is rammed, and the upper sand sculpture is piled.

S2: A form is mounted and sand is piled: as shown in FIG. 2, the vertical form 2 is mounted above the foundation 1, and the form 2 is filled with the sand. A thickness of the sand for filling each time is 10-30 cm. A specific thickness depends on a particle size and grain composition of the sand.

S3: Pouring and ramming are carried out: as shown in FIG. 3, the diagenetic cementation solution is poured into an outer surface layer of the sand in region I 10-20 cm away from the form, and water is poured into the sand in region II at an inner side after the sand is piled. A pouring volume of the diagenetic cementation solution is 1.5-3 times a natural pore volume of the sand, and a pouring volume of the water is 1.5-3 times the natural pore volume of the sand. Each layer of regional pouring may ensure a treatment effect, and a hardened layer bonded by a diagenetic reaction on an outer surface may not only prevent a surface of a sand sculpture from weathering, reduce evaporation of the water, and but also greatly reduce cost. Ramming is carried out after each layer is poured, ramming is carried out repeatedly from each poured point to mix the sand with the cementation solution or the water. A method of ramming after pouring may not only ensure that the sand absorbs the water to produce cohesion, but also ensure that the diagenetic cementation solution is uniformly mixed with the sand, and finally calcite crystals may be better produced between grit particles.

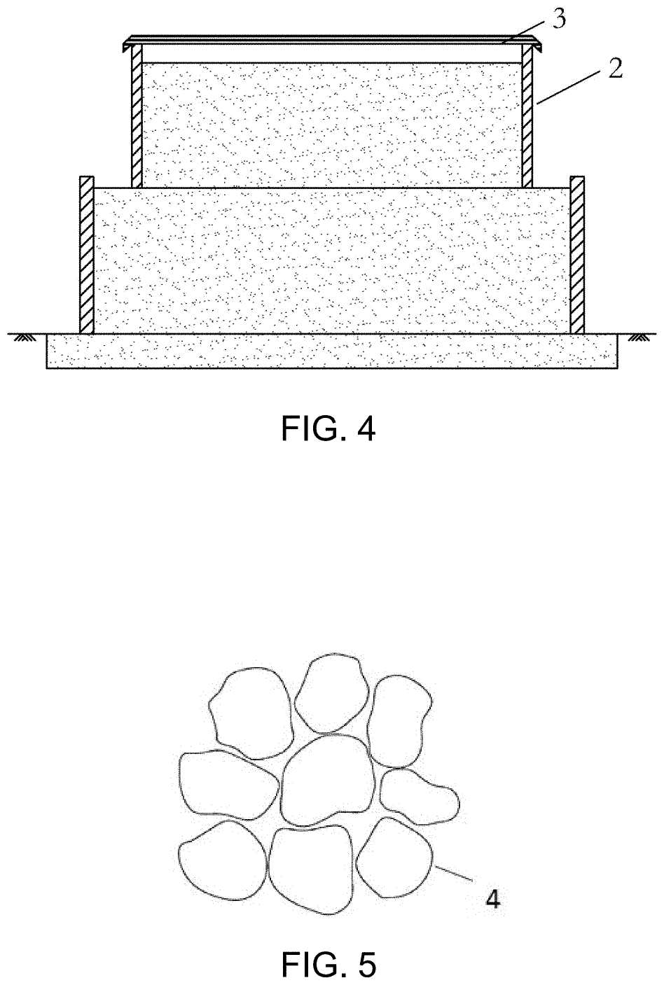

S4: As shown in FIG. 4, the step S2 and the step S3 are repeated until a sand pile reaches a designed height and size, and finally the diagenetic cementation solution with a volume of 1.5-3 times the natural pore volume of the sand is poured into a top for ramming. If a sunshine intensity is high or wind is strong after a top layer is poured, the top layer is covered with a plastic film 3 or geotextile to prevent water at the top from evaporating too fast and make the diagenetic reaction complete.

S5: The form is removed and sculpturing is carried out: the form is removed in about three days after the sand is piled, so as to ensure that the sand is dense and fully reacts under an action of self-weight. The form is removed from top to bottom, one layer is removed, then the layer is sculptured, each layer is sculptured according to a design solution until the bottommost layer is removed, and the bottommost layer is sculptured to complete the environmentally friendly sand sculpture.

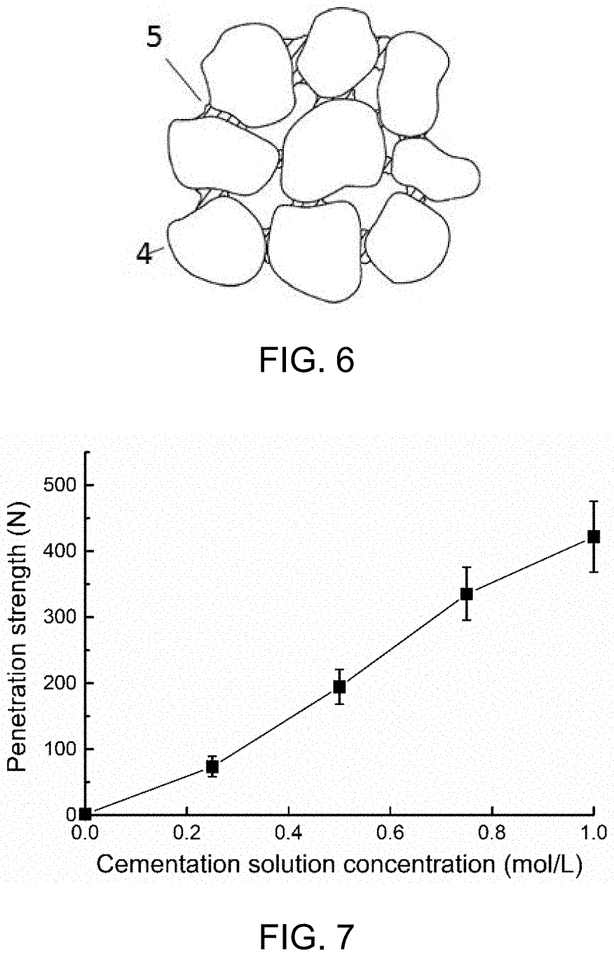

As shown in FIG. 5, the sand particles 4 are in a free and loose state before the diagenetic cementation solution is poured. As shown in FIG. 6, the diagenetic cementation solution obtained by adding the urease-containing plant powder, the urea and the calcium salt into the cementation solution and mixing same is poured on the surface of the sand sculpture, such that calcite 5 may be generated between the sand particles 4 to bond adjacent sand particles 4. However, under a normal condition, the diagenetic reaction is extremely slow. Accordingly, some natural plant tissues rich in urease of beans, melons, pines, etc. are used for being mixed into the cementation solution, so as to use a characteristic of the urease to promote a urea hydrolysis reaction to accelerate formation of carbonates, with increase of pH of the reaction, calcium ions are combined with the carbonates, and finally the calcite 5 is formed between the sand particles 4. In this process, the cementation solution with high viscosity may slow down infiltration of a liquid in a reaction process, thereby increasing formation of the calcite 5 between the sand particles 4 so as to bond the sand particles 4 together.

Compared with a conventional sand sculpture curing agent, the diagenetic cementation solution has the following advantages.

(1) An effusion is not prone to be generated on a surface of the sand in a treatment process since viscosity of the diagenetic cementation solution is low and an infiltration speed of the diagenetic cementation solution in the sand, especially fine sandy soil, is quicker, while an effusion is prone to be generated on a surface of sand in a spraying process of the curing agent, affecting a subsequent curing effect since the curing agent has high viscosity and poor infiltration in a treatment process of the traditional sand sculpture curing agent.

(2) The diagenetic cementation solution uses the plant urease, the urea and a soluble calcium source, while the traditional sand sculpture curing agent mostly uses chemical synthetic substances, which contain varying amounts of chemical additives. Compared with the traditional sand sculpture curing agent, the diagenetic cementation solution is more environmentally friendly.

(3) A principle of curing the sand by the diagenetic cementation solution is biomineralization, that is, the plant urease catalyzes a reaction between the urea and the soluble calcium source, so as to form the calcite crystals having a bonding function between the sandy soil particles. The calcite crystals are insoluble in the water and have excellent chemical and thermal stability. Accordingly, compared with the traditional sand sculpture curing agent, an effect of curing the sand by the diagenetic cementation solution is more enduring, and the diagenetic cementation solution is not prone to fail by an influence of natural factors of a high temperature, rainwater, etc.

### Specific Embodiment

A diagenetic cementation solution is prepared from a urease-containing plant powder and a cementation liquid in a volume ratio of 1:1.

A method for preparing a diagenetic cementation solution includes the following steps.

(1) Urease-containing plant powder is acquired: 100 g of dry soybeans is weighed with an electronic balance, same is put into a crusher for crushing, sieving is carried out with a 60-mesh screen to obtain a required soybean powder, and the prepared soybean powder is stored in a sealed manner for later use so as to prevent deterioration; and 160 g of the soybean powder and 1000 ml of water is added into a beaker, and same is fully stirred uniformly by means of a magnetic stirrer until a concentration of the soybean powder is 160 g/L, a soybean powder-water mixture in the beaker is poured into a centrifugal tube after 0.5 h, the centrifugal tube is placed in a centrifuge, centrifugation is carried out for 15 min at a rotational speed of 4000 r/min, sediment at a bottom of the centrifugal tube is discarded, and a supernate is extracted from the centrifugal tube to obtain a plant urease crude extract containing urease.

(2) The diagenetic cementation solution is prepared: a concentration ratio of urea to calcium salt in the diagenetic cementation solution is set to be 1:1; and a mixture of the urea and calcium chloride with different mass is added into the plant urease crude extract containing urease, so as to make concentrations of the urea and the calcium chloride in a final plant urease crude extract be 0.25 mol/L, 0.5 mol/L, 0.75 mol/L and 1 mol/L separately.

(3) A sand sample is prepared and sprayed: sandy soil used in a test is aeolian sand taken from a tengger desert on site, the sandy soil is poured into a stainless steel tray with a dimension of length×width×height of 26 cm×18 cm×5 cm, and a surface of the sample is treated flat; a spraying device of a watering can, etc. is used for spraying the diagenetic cementation solution prepared in step (2) on a surface of the sandy soil, and spraying amount is 4 L/m²; 4 sand samples is placed on a test table for 48 h after spraying, to ensure that the diagenetic cementation solution reacts completely on the surface of the sandy soil; and finally, the sample is placed in an oven at 60° C. for 24 h to dry same.

(4) Strength is tested: a penetration test is carried out on 4 samples treated with the diagenetic cementation solution, 1 sample treated with a conventional sand sculpture curing agent and 1 untreated control sample, penetration strength is measured by a flat bottom circular penetrometer, a diameter of a cylindrical rod and a penetration speed of the penetrometer are 5 mm and 3 mm/min separately, the penetration strength of the treated sample is shown in FIG. 7, the penetration strength of the untreated control sample is 1.4 N, the penetration strength of the sample treated with the conventional sand sculpture curing agent is 396.2 N, and as shown in FIG. 7, with increase of a concentration of the urea (calcium chloride), the penetration strength of the sample is remarkably improved, and a maximum may reach about 421.6 N.

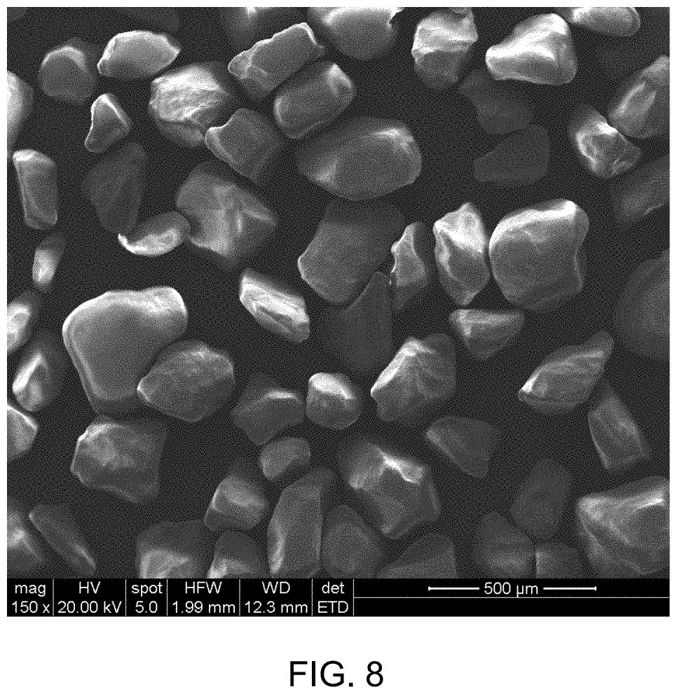

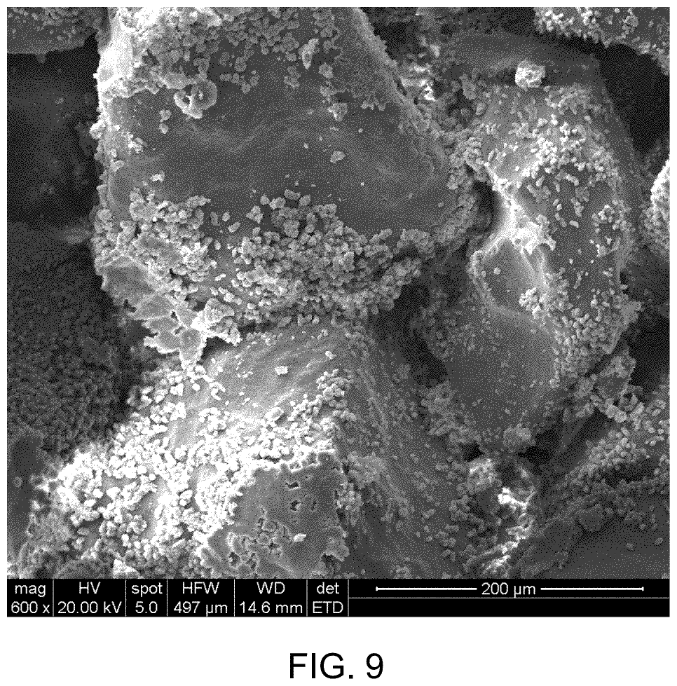

(5) Electron microscope scanning is tested: sampling is carried out from surfaces of the untreated sample and the sample treated with the diagenetic cementation solution with a concentration of 1 mol/L of urea (calcium chloride) for electron microscope scanning testing, test results are shown in FIGS. 8 and 9, where FIG. 8 shows the result of the untreated sample, and

FIG. 9 shows the result of the sample treated with the diagenetic cementation solution; it may be seen from the figures that the untreated sandy soil is in a loose state (FIG. 8), while a certain number of calcium carbonate crystals are formed between sandy soil particles of the sandy soil treated with the diagenetic cementation solution (FIG. 9); and the calcium carbonate crystals bond the loose sandy soil particles together by bridging and filling, and form a soil aggregate, thereby improving strength of the sandy soil so as to achieve a purpose of sand sculpture curing (FIG. 9).

In step (4), the conventional sand sculpture curing agent is a diluted white latex, where the white latex and water are diluted in a volume ratio of 1:9, spraying amount and a treatment method of the conventional sand sculpture curing agent are the same as those of the diagenetic cementation solution in step (3).

1. A diagenetic cementation solution, comprising a urease-containing plant powder, urea, calcium salt and a cementation solution, wherein the urease-containing plant powder is dissolved in the cementation solution in a mass ratio of 10:50 to 1:50, a resulting mixture is stirred and left to stand for a period of time, and a supernate is reserved; and a mixture of the urea and the calcium salt is dissolved in the supernate in a mass ratio of 1:5 to 1:20.

2. The diagenetic cementation solution according to claim 1, wherein the calcium salt is one or more from the group consisting of calcium chloride, calcium formate and calcium nitrate, and a mass ratio of the urea to the calcium salt in the mixture of the urea and the calcium salt is 1:1 to 1:2.

3. The diagenetic cementation solution according to claim 1, wherein the calcium salt is calcium acetate, and a mass ratio of the urea to the calcium salt in the mixture of the urea and the calcium salt is 3:8 to 6:8.

4. The diagenetic cementation solution according to claim 2, wherein the urease-containing plant powder is ground from one or more from the group consisting of sword beans, soybeans, pine leaves and watermelon seeds.

5. The diagenetic cementation solution according to claim 4, wherein the cementation solution is prepared by dissolving one of gelatin, xanthan gum or carrageenan in water in a mass ratio of 0.5%.

6. A method for preparing the diagenetic cementation solution according to claim 1, comprising the following steps:
step 1, acquiring the urease-containing plant powder: weighing 100 g of dry soybeans with an electronic balance, putting same into a crusher for crushing, sieving with a 60-mesh screen to obtain a required soybean powder, and storing the prepared soybean powder in a sealed manner for later use so as to prevent deterioration; and adding 160 g of the soybean powder and 1000 ml of water into a beaker, and fully stirring same uniformly by means of a magnetic stirrer until a concentration of the soybean powder is 160 g/L, pouring a soybean powder-water mixture in the beaker into a centrifugal tube after 0.5 h, placing the centrifugal tube in a centrifuge, carrying out centrifugation for 15 min at a rotational speed of 4000 r/min, discarding sediment at a bottom of the centrifugal tube, and extracting a supernate from the centrifugal tube to obtain a plant urease crude extract containing urease;
step 2, preparing the diagenetic cementation solution: setting a concentration ratio of urea to calcium salt in the diagenetic cementation solution to be 1:1; and adding a mixture of the urea and calcium chloride with different mass into the plant urease crude extract containing the urease, so as to make concentrations of the urea and the calcium chloride in a final plant urease crude extract be 0.25 mol/L, 0.5 mol/L, 0.75 mol/L and 1 mol/L separately; and
step 3, mixing: mixing the soybean urease-containing plant powder with an inorganic treatment solution in a volume ratio of 1:1 before use, to prepare the diagenetic cementation solution.

7. A method for manufacturing a sand sculpture, comprising the following steps:
step S1, ramming a foundation: pouring water or a diagenetic cementation solution into the foundation, simultaneously adding sand, and ramming or rolling the foundation at the same time;
step S2, mounting a form and piling sand: mounting a vertical form above the foundation and filling the form with the sand;
step S3, pouring and ramming: pouring the diagenetic cementation solution into an outer surface layer of the sand 10-20 cm away from the form, and pouring water into the sand at an inner side after the sand is piled each time; and ramming each layer of sand after pouring;
step S4, repeating the step S2 and the step S3 until a sand pile reaches a designed height and size, finally pouring the diagenetic cementation solution into a top layer of the sand pile and ramming same; and
step S5, removing the form and carrying out sculpturing: carrying out form removing and sculpturing in three days after sand piling and pouring.

8. The method for manufacturing the sand sculpture according to claim 7, wherein a thickness of the sand for filling each time in the step S2 is 10-30 cm.

9. The method for manufacturing the sand sculpture according to claim 7, wherein a pouring volume of the diagenetic cementation solution in the step S3 is 1.5-3 times a natural pore volume of the sand.

10. The method for manufacturing the sand sculpture according to claim 8, wherein a pouring volume of the water in the step S3 is 1.5-3 times a natural pore volume of the sand.

11. The diagenetic cementation solution according to claim 3, wherein the urease-containing plant powder is ground from one or more from the group consisting of sword beans, soybeans, pine leaves and watermelon seeds.

12. A method for preparing the diagenetic cementation solution according to claim 2, comprising the following steps:
step 1, acquiring the urease-containing plant powder: weighing 100 g of dry soybeans with an electronic balance, putting same into a crusher for crushing, sieving with a 60-mesh screen to obtain a required soybean powder, and storing the prepared soybean powder in a sealed manner for later use so as to prevent deterioration; and adding 160 g of the soybean powder and 1000 ml of water into a beaker, and fully stirring same uniformly by means of a magnetic stirrer until a concentration of the soybean powder is 160 g/L, pouring a soybean powder-water mixture in the beaker into a centrifugal tube after 0.5 h, placing the centrifugal tube in a centrifuge, carrying out centrifugation for 15 min at a rotational speed of 4000 r/min, discarding sediment at a bottom of the centrifugal tube, and extracting a supernate from the centrifugal tube to obtain a plant urease crude extract containing urease;
step 2, preparing the diagenetic cementation solution: setting a concentration ratio of urea to calcium salt in the diagenetic cementation solution to be 1:1; and adding a mixture of the urea and calcium chloride with different mass into the plant urease crude extract containing the urease, so as to make concentrations of the urea and the calcium chloride in a final plant urease crude extract be 0.25 mol/L, 0.5 mol/L, 0.75 mol/L and 1 mol/L separately; and
step 3, mixing: mixing the soybean urease-containing plant powder with an inorganic treatment solution in a volume ratio of 1:1 before use, to prepare the diagenetic cementation solution.

13. A method for preparing the diagenetic cementation solution according to claim 3, comprising the following steps:
step 1, acquiring the urease-containing plant powder: weighing 100 g of dry soybeans with an electronic balance, putting same into a crusher for crushing, sieving with a 60-mesh screen to obtain a required soybean powder, and storing the prepared soybean powder in a sealed manner for later use so as to prevent deterioration; and adding 160 g of the soybean powder and 1000 ml of water into a beaker, and fully stirring same uniformly by means of a magnetic stirrer until a concentration of the soybean powder is 160 g/L, pouring a soybean powder-water mixture in the beaker into a centrifugal tube after 0.5 h, placing the centrifugal tube in a centrifuge, carrying out centrifugation for 15 min at a rotational speed of 4000 r/min, discarding sediment at a bottom of the centrifugal tube, and extracting a supernate from the centrifugal tube to obtain a plant urease crude extract containing urease;
step 2, preparing the diagenetic cementation solution: setting a concentration ratio of urea to calcium salt in the diagenetic cementation solution to be 1:1; and adding a mixture of the urea and calcium chloride with different mass into the plant urease crude extract containing the urease, so as to make concentrations of the urea and the calcium chloride in a final plant urease crude extract be 0.25 mol/L, 0.5 mol/L, 0.75 mol/L and 1 mol/L separately; and
step 3, mixing: mixing the soybean urease-containing plant powder with an inorganic treatment solution in a volume ratio of 1:1 before use, to prepare the diagenetic cementation solution.

14. A method for preparing the diagenetic cementation solution according to claim 4, comprising the following steps:
step 1, acquiring the urease-containing plant powder: weighing 100 g of the dry soybeans with an electronic balance, putting same into a crusher for crushing, sieving with a 60-mesh screen to obtain a required soybean powder, and storing the prepared soybean powder in a sealed manner for later use so as to prevent deterioration; and adding 160 g of the soybean powder and 1000 ml of water into a beaker, and fully stirring same uniformly by means of a magnetic stirrer until a concentration of the soybean powder is 160 g/L, pouring a soybean powder-water mixture in the beaker into a centrifugal tube after 0.5 h, placing the centrifugal tube in a centrifuge, carrying out centrifugation for 15 min at a rotational speed of 4000 r/min, discarding sediment at a bottom of the centrifugal tube, and extracting a supernate from the centrifugal tube to obtain a plant urease crude extract containing urease;
step 2, preparing the diagenetic cementation solution: setting a concentration ratio of urea to calcium salt in the diagenetic cementation solution to be 1:1; and adding a mixture of the urea and calcium chloride with different mass into the plant urease crude extract containing the urease, so as to make concentrations of the urea and the calcium chloride in a final plant urease crude extract be 0.25 mol/L, 0.5 mol/L, 0.75 mol/L and 1 mol/L separately; and
step 3, mixing: mixing the soybean urease-containing plant powder with an inorganic treatment solution in a volume ratio of 1:1 before use, to prepare the diagenetic cementation solution.

15. A method for preparing the diagenetic cementation solution according to claim 5, comprising the following steps:
step 1, acquiring the urease-containing plant powder: weighing 100 g of the dry soybeans with an electronic balance, putting same into a crusher for crushing, sieving with a 60-mesh screen to obtain a required soybean powder, and storing the prepared soybean powder in a sealed manner for later use so as to prevent deterioration; and adding 160 g of the soybean powder and 1000 ml of water into a beaker, and fully stirring same uniformly by means of a magnetic stirrer until a concentration of the soybean powder is 160 g/L, pouring a soybean powder-water mixture in the beaker into a centrifugal tube after 0.5 h, placing the centrifugal tube in a centrifuge, carrying out centrifugation for 15 min at a rotational speed of 4000 r/min, discarding sediment at a bottom of the centrifugal tube, and extracting a supernate from the centrifugal tube to obtain a plant urease crude extract containing urease;
step 2, preparing the diagenetic cementation solution: setting a concentration ratio of urea to calcium salt in the diagenetic cementation solution to be 1:1; and adding a mixture of the urea and calcium chloride with different mass into the plant urease crude extract containing the urease, so as to make concentrations of the urea and the calcium chloride in a final plant urease crude extract be 0.25 mol/L, 0.5 mol/L, 0.75 mol/L and 1 mol/L separately; and
step 3, mixing: mixing the soybean urease-containing plant powder with an inorganic treatment solution in a volume ratio of 1:1 before use, to prepare the diagenetic cementation solution.
